(19) United States
(12) Patent Application Publication
(10) Pub. No.: US 2010/0287042 A1
(43) Pub. Date: Nov. 11, 2010

(54) KNOWLEDGE CREATION SYSTEM FOR A SPONTANEOUS ONLINE COMMUNITY

(76) Inventor: Ming Han Chang, Taipei (TW)

Correspondence Address: MING HAN CHANG, 5F 18-2 Jinan Road Section Two, TAIPEI CITY, 100, TW

(21) Appl. No.: 12/758,200

(22) Filed: Apr. 12, 2010

Related U.S. Application Data
(60) Provisional application No. 61/168,827, filed on Apr. 13, 2009.

(51) Int. Cl. G06Q 30/00

(52) U.S. Cl. 705/14.11

(57) ABSTRACT

A method for evaluating and rewarding users' contribution in an Internet system is described. The Internet system accepts user's contribution of articles or multimedia information. The system maintains user profiles. Each user profile comprises a reputation data and a credit data. The Internet system has four kinds of roles to participate in pages of a platform uses one language. The received contribution subject to other's modifications, and system evaluates contribution ratio and page production value to reward the contribution for a certain time.

### CROSS-REFERENCE TO RELATED APPLICATIONS

This application claims the benefit of provisional patent application Ser. No. 61/168,827, filed Apr. 13, 2009 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The application relates to a knowledge creation system for an online community. More particularly, it is a cooperative platform to contribute knowledge to the community.

The rapid development of Internet makes it easy for users to find what they want. The online search engine or theme oriented forums are very popular in the Internet. However knowledge obtained from either search results or forum post is sparse and of unstable quality. Other websites like Yahoo Knowledge or Yahoo Answers is another functional website provide knowledge or answer. Each post with questions and answers is not collected by edition. Those posted article are still sparse and users still rely on search engine to find out the knowledge related to their questions. These search engines often answer user queries with large amount of irrelevant knowledge.

Compared those knowledge platforms, the creation of Wikipedia provide not only a structured content for knowledge presentation (like a book) but also a platform for community member to edit article. As the founder of Wikipeida Mr. Jimmy Wale claimed, the website is served “to share and synchronize local and personal knowledge, allowing society's members to achieve diverse, complicated ends through a principle of spontaneous self-organization.”

Currently, so-called web 2.0 platform like Wikipedia or YouTube requires users to voluntarily provide their creations to enrich the content of the platform. It works for years. However such cooperative platforms provide pretty poor long-term incentives for participants. For those commercial web 2.0 sites, the values of such websites are created by those voluntary contributions and those website owners get benefits by realizing those values.

### BRIEF SUMMARY OF THE INVENTION

In accordance with one embodiment, a method for evaluating and rewarding a contribution of a user in an Internet system that comprises a user profile including a reputation data and a credit data comprises receiving said contribution subject to a second user's modification, and evaluating contribution ratio and page production value to reward said user a credit for said contribution for a certain time.

### BRIEF DESCRIPTION OF THE DRAWING

FIG. 1 shows an illustration of the participants' role in accordance with one embodiment.

FIG. 2 shows an exemplary user's access in accordance with one embodiment.

FIG. 3 shows one page structure in accordance with one embodiment.

FIG. 4 shows one flowchart operation in accordance with one embodiment.

FIG. 5a shows an operation procedure with time line in accordance with one embodiment.

FIG. 5b shows a credit calculation method in accordance with one embodiment.

FIG. 6 shows pluralities of group compositions in one page in accordance with one embodiment.

FIG. 7 shows a system network employing two cooperative platforms in accordance with one embodiment.

FIG. 8 shows a Viking ship with a steering paddle.

### DETAILED DESCRIPTION OF THE INVENTION

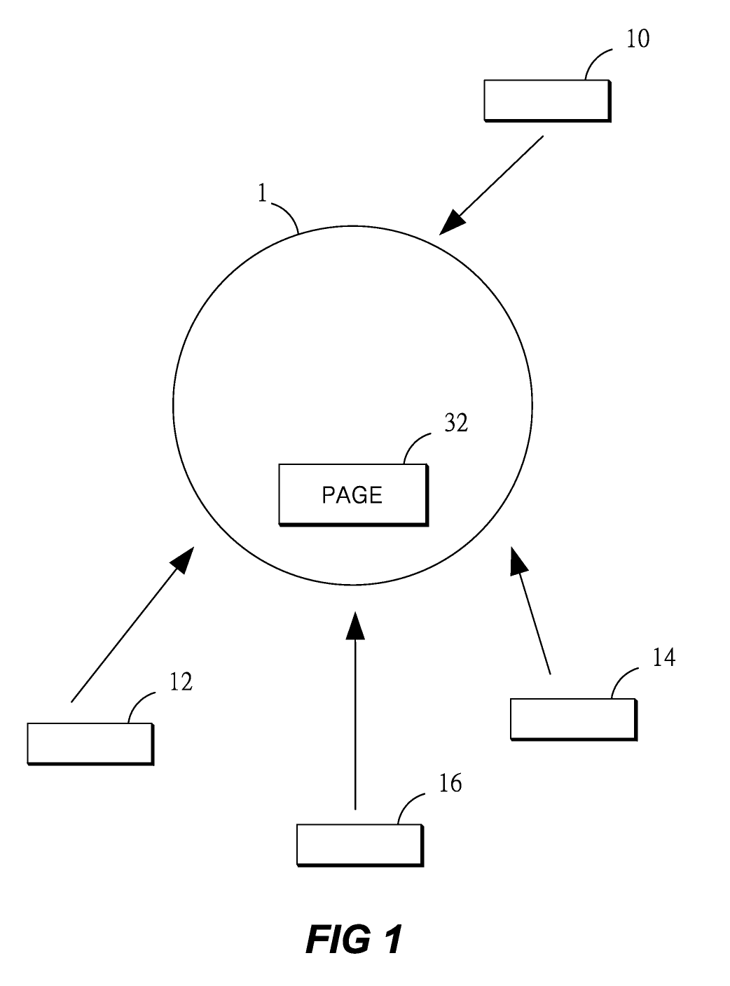

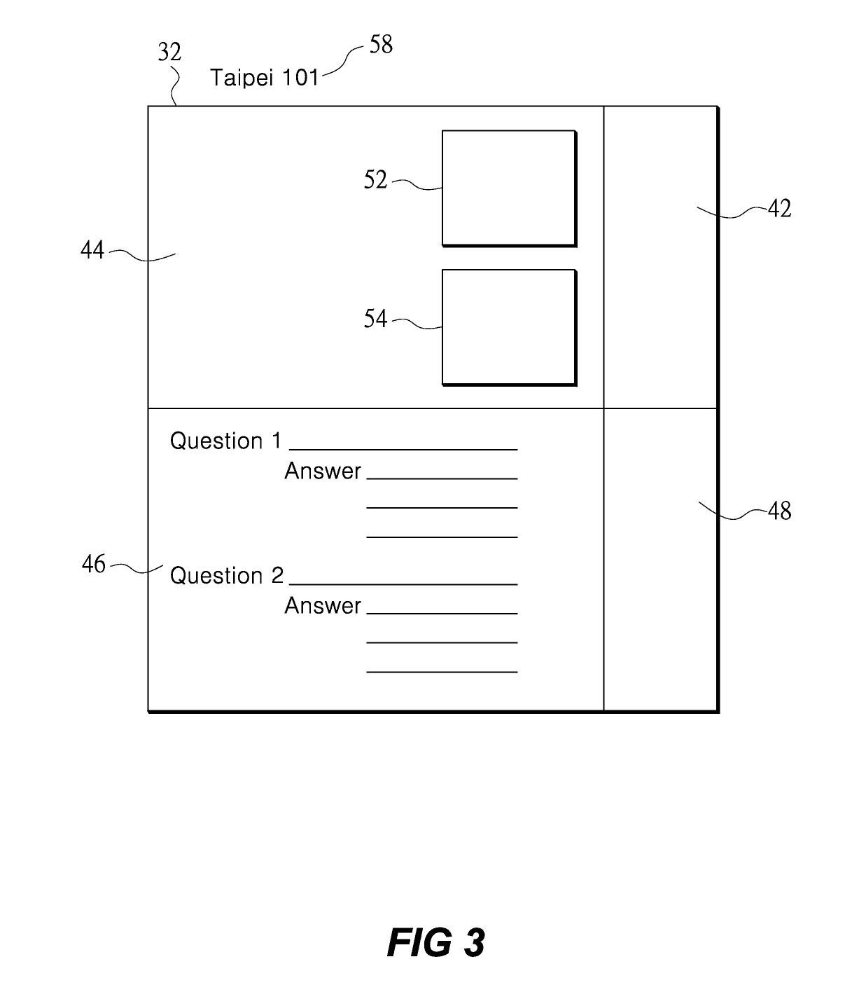

One embodiment of the system is explained in more detail in FIG. 1. It shows four roles of participants in a cooperative working platform 1. Contributors 14 add and append new sentences or articles in a page 32 of the platform 1. The page 32 is illustrated in FIG. 3. Usually the page includes one topic or one point of interest for a geographical region. Contributors 14 could put picture or other multimedia for that page. Editors 12 perform edition works such as delete, rephrase, rearrange or redesign a page. Editors 12 would provide a primary censorship toward the page that they have merits on it. Viewers 16 are a group people read and review the article or pages. Different from Contributors 14, Editors 12, Viewers 16 do not need to login to read or search the page. Viewers 16 together with editors 12 both could mark up a section of article to reflect superfluous or redundant words. Usually a section or a portion of the article is required a rephrase or rewrite by at least two situations. First is that section has errors and second is that the section has redundant words and could be more concise. Editors 12 together with viewers 16 could report vandalism. Basically, a user could switch from the role as Contributors 14 and Viewers 16 easily. And when a contributor has more and more interests in that page, he could become the editor. Moreover, while more and more viewers visit and read the page or the page's content increases greatly, the system will raise a need for an administrator. Administrators 10 are a group of people mainly set up rules, adjust rates, moderate conflicts and perform management work such as holding the editors' meetings. Administrators 10 may have hierarchy such as local administrators or central administrators. However one main function of Administrators 10 is to maintain a fair rule and policy. Pages may have subordination relationship with each others such as Taipei 101 building to Taipei city. Therefore one administrator for Taipei city may at same time manage several sub-pages.

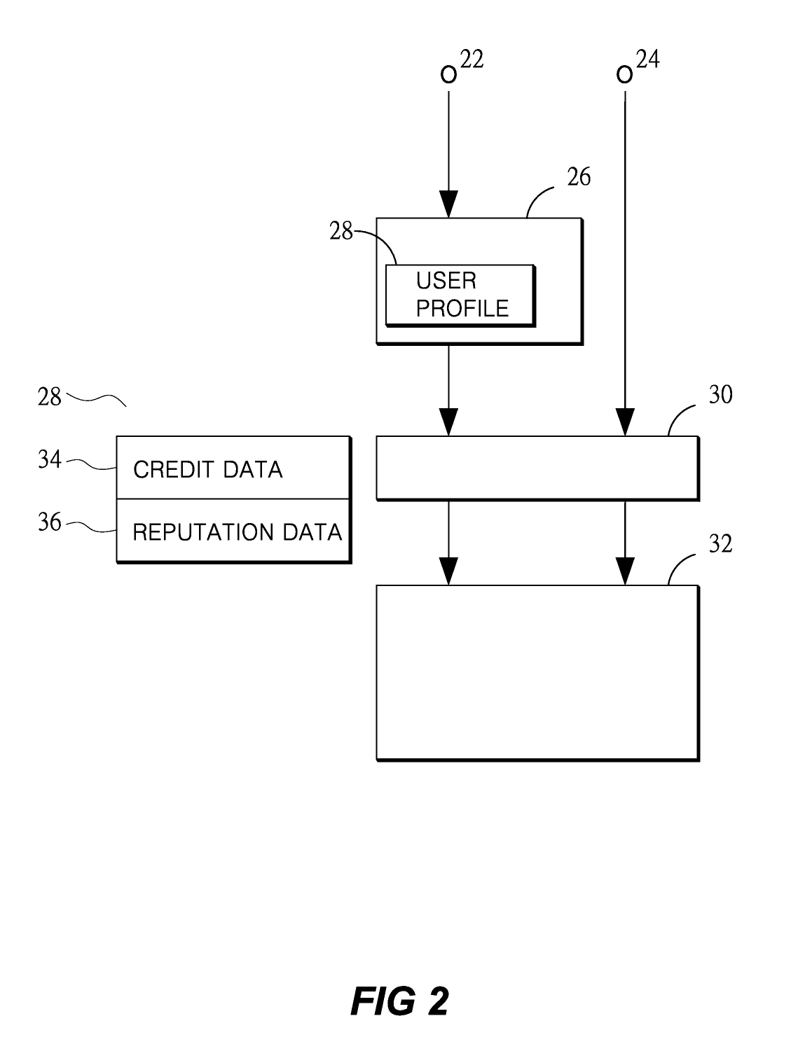

FIG. 2 shows an exemplary user's access. Two users use Internet to access the system. User 24 does not log into the system therefore user 24 could not perform any actions as Editors 12, Contributors 14 or Administrators 10. User 22 logs into system through the login module 26. The login module 26 will compare with user 22 information in the user profile 28 to authorize the access. In the user profile 28, there are at least two kinds of data-credit data 34 and reputation data 36. Credits data are user's credits values resulted from user's contributions to the platform 1. The reputation point stored in the reputation data 36 reveals the trustworthy degree and friendly degree to that community. By contributing to the platform 1, in one embodiment, the reputation points increase by the accuracy of your contribution in each time. However while your contribution is reported or evaluated by Viewer 16, Editors 12, Contributors 14 or Administrators 10 to be reckless or intentional to contribute errors or repetitively contribute redundant words or even rewrite the article un-neutrally due to your or others' commercial interests, reputation points decrease accordingly. In the same token, the friendliness is measured by your participation frequency or community member's subjective feeling about your participation in the pages. Taken subjective feeling as examples, friendliness increase when people felt your answer is always sincere, you had participated in many dispute resolutions with good records or your responses are always kind and fast. This friendly degree is often an add-on point rather than a deduction to the reputation point. It should be noted that each page that has different contents in nature might have its policy to punish such untrustworthy or to grant friendliness points.

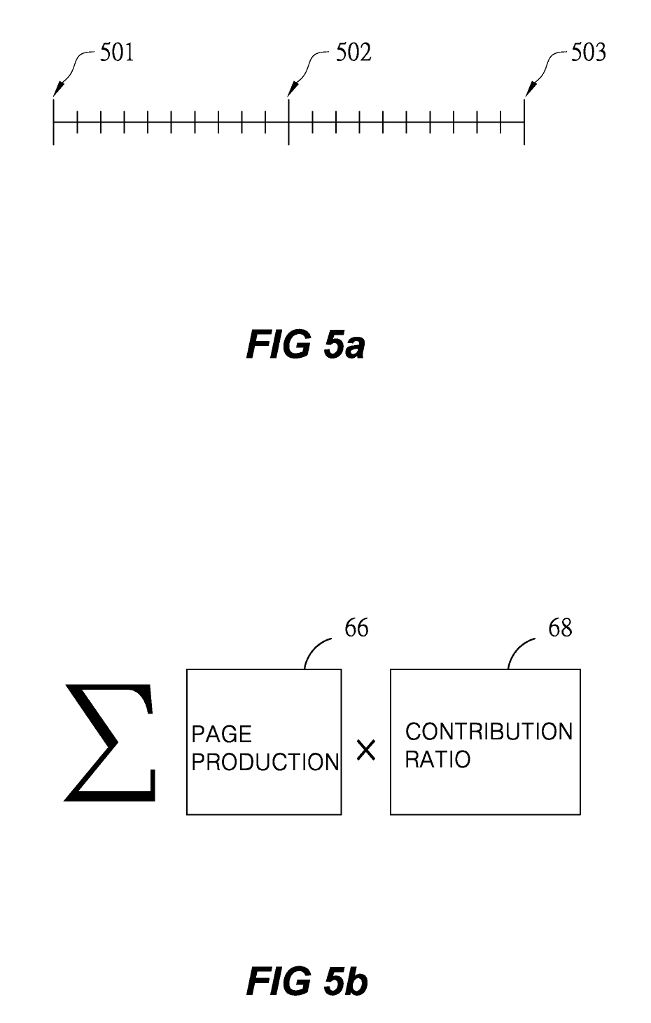

In FIG. 2, the system will perform web page analytics 30 for each access to said page 32. The result of web page analytics 30 shows how attractive is this page 32 to users. The result of such analytics is an indication of the pages, which is used to form page production 66 in FIG. 5b. Web page analytics 30 records data for the later calculation of page production 66. The data being recorded during a certain time period includes but not limited to the hits data, pages views data, page views duration data, frequency data (first time and repeated user) and etc. The page production 66 is an accumulated value of the recorded data. Such results show how Internet users views and makes usages of the page; briefly we referred it as page production in this disclosure.

FIG. 3 shows one exemplary page 32 generated by the system. The page 32 may include four main areas, article area 44, question and answer area 46, dynamic data area 42 have information related to the title 58 and comments and announcement area 48. Article area 44 has organized knowledge and may include the structured content list. It is one example that the appearance of article area 44 could be designed similar to the pages of wikipedia. In the article area 44 may also have picture 52 or multimedia 54 corresponding to the word description in the article area 44. Question and answer area 46 allows user to post their questions related to the title 58 and to give answers or comments to such questions. Each question and answers sets could be a source to contribute knowledge to said article area 44. The Question and answer area 46 is a raw knowledge pool. The raw knowledge should be digested and then be entered into the article area 44. The dynamic area 42 shows more real time information. Such information could automatically feed in by RSS technology, Twitter technology or even simple output from other web feed such as the weather or traffic information. The comment and announcement area 48 allows administrator 10 to announce page policy and adjusted rules and also allows user to post their comment or report any vandalism or a proposal to a rule change. The title 58 may include tags or categories information behind. That information is important to build a well-maintained index for the platform. Finally, the operation and content of page 32 should be as neutral as possible. Therefore it is possible to design another page depending on this page 32 (as indicated by another tab index in the page 32) to allow the commercial company or interested organization to show their products or to promote their coming activities.

While making contribution in the page 32, especially in the article area 44, contributor 14 could directly added new sentences or other media format on it and editor 12 may directly edit the page and delete a portion of error information. Such deletion or edition will be automatically sent to the original contributors 14 for a notice. Such contributors 14 have rights to raise opposition. Participants may have right to mark up the superfluous portion by highlighting that portion. It is a design of editing mode. More users highlight the same sentences, that sentences may be covered by a more dense color. The highlighted portion will not be shown in the normal mode. In the editing mode, the system may also show a recent contribution with a different color or font size.

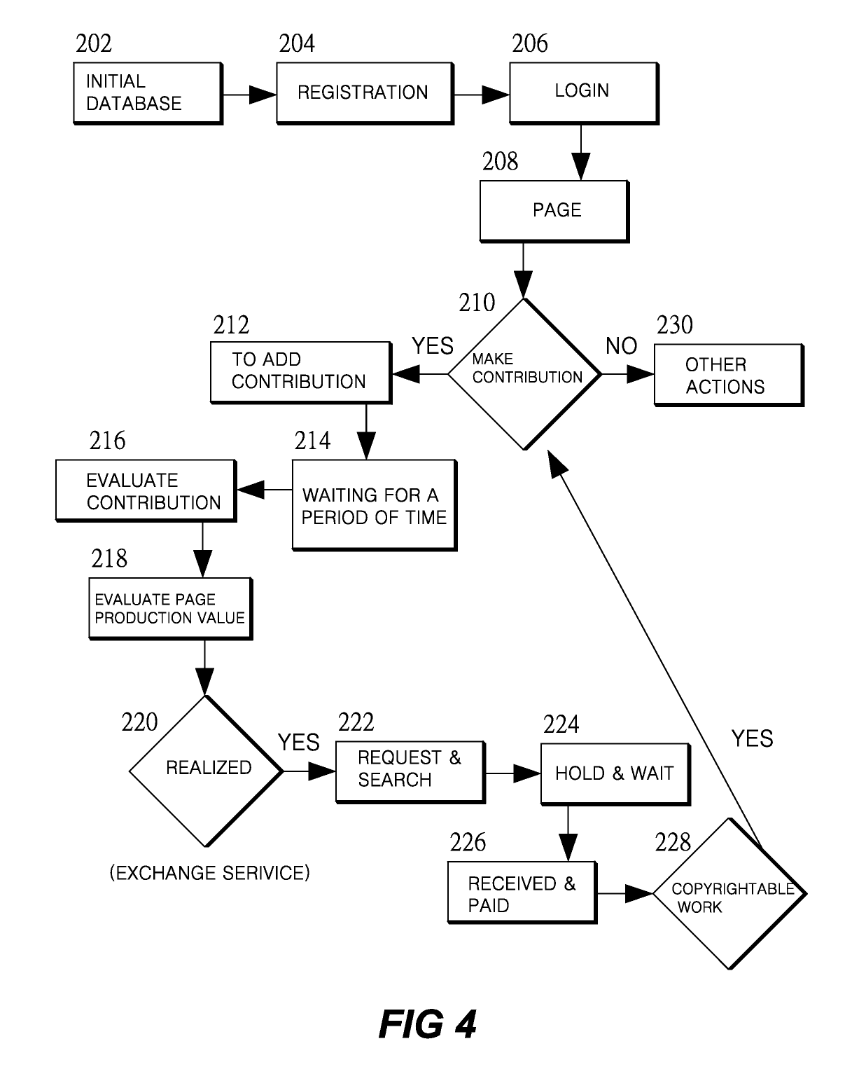

FIG. 4 shows an exemplary system operation by a flowchart. The exemplary method begins at step 202. In the beginning, the platform builder establishes an initial version of platform. The builder would set up structured index and grouped categories. The builder may fill in some knowledge for some important topics or titles. The initial title names are also set. For example, if the platform's focus is geographical area, the builder would use the name of point of interest as the title of the page and make a structured index according to the scope of geographical area. The builder further includes sub-topics for each point of interest.

Step 204 accepts user to register to become the member of the platform. Basically all users registered as a member in the platform with equal start-up condition. However in another exemplary situation, some users may be registered as higher start-up condition if such users receive special invitation to register based on their expertise in some topics.

Step 206 verifies registered user's log in. As explained before, the login module 26 compares with user's input information in the user profile 28 to authorize the access. After log in, the system will load such user's profile information and based on such information to perform subsequent procedures.

While entered step 208 the platform system may show the home page of the platform or the last page the user worked on or reviewed. From this step, the user decides to contribute to said page or to do other things such as reviewing or searching in the decision step 210. A user's decision to make contributions to a page in the platform branches execution to step 212. A user's decision not to make contributions branches execution to step 230 to perform other actions. In the step 212, the platform system adds such contributions and shows the contributions in the pages. It is an exemplary practice to show or reveal the contribution or the result after edition and subjects to others correction or edition later on, which is the uniqueness of wild-style practice. In this step, however, to avoid unpleasant materials such as picture or words shown up, the platform system may perform a censorship check automatically not based on the relevancy or authentication but based on the children protection.

In step 214, the platform waits for a time period to go to next step. The length of said time period depends on the reputation point of each contributor. The reputation points as its name explains itself is used to predict how many modifications on the later contribution of the user. Therefore each user's waiting time may be different. The rationale to have such waiting time is to guarantee other users have opportunity to review the contribution and correct them. Therefore we can shorten waiting time for the people with higher reputation points. It is reasonable to expect a trustworthy people raise less issues than others. It means that we can trust the user with higher reputation points that less modification would occur in the user's contribution. Of course the waiting time may be extended by certain circumstances such as a dispute or appealing procedure is on going. The waiting time may be also scaled for different page since some pages may have more controversial topics and the page is in the very unstable state for a certain time.

Step 216 and Step 218 together called reward calculation steps. In step 216, contribution would be evaluated against all or partial contents of the page the contribution is belonged to. Step 216 will generate a contribution ratio 68 in FIG. 5b. In one embodiment, the contribution ratio 68 is calculated by this ratio: (words counts of remained contribution/words counts of the page). To evaluate the page production in step 218, there are some indicators to score the contribution such as citation, pagelink, relevancy, favored term/rare term analysis or quality of the article. By multiplying page production 66 as in FIG. 5b and contribution ratio 68, one's contribution could be converted into a rewarding value, as we called it credit value or just called it credit in this disclosure. In other words, in the rewarding calculation steps, by using the formula shown in FIG. 5b, the platform system rewards contribution based on how much you contribute to the page and based on productive performance of this page.

Temporally referring to FIG. 5a, it shows a time line to show the step 212 to step 220 in the flowchart. In FIG. 5a, there are three main time points, the submitted date 501, the realizable date 502, and the realized date 503 (as the step 220 in FIG. 4). The waiting time is the period of time between the submitted date 501 and the realizable date 502. In one embodiment, the rewarding time is time period between the submitted date 501 and an actual reward date. The actual reward date is decided by the user of contribution and should be equal to or later than the realizable date 502 and equal to or before to the realized date 503. In a short, the actual reward date could be any date between the realizable date 502 and the realized date 503.

As the timeline shown in FIG. 5a passed, it is foreseeable that after receiving accumulated contributions and edition, the page contains more and more useful knowledge and more and more people make usage of this page, therefore the increasing rate of the page production goes sharp accordingly. The main idea of the rewarding is to reflect one goal of this invention: contributors harvest the fruits of their hard working by enriching the content of a page.

The numerator of the contribution ratio 68 is the word counts of remained contribution after edition and correction. Remained contribution means that after original contribution is filtered or screened, what is remained for the contribution after a certain time. The remained contribution may be less than the original contribution as the submitted date 501 in FIG. 5a.

As mentioned before, each element of exemplary equation in FIG. 5b may change over the time. First is the page production 66. Each date has its page production value and total page production over a certain time period will be a sum of each individual date's page production. Second is the contribution ratio 68. The content of the page may increase or decrease from time to time. There are several methods to decide the value of the denominator of contribution ratio 68. The denominator of contribution ratio 68 could be calculated from either a count of the content of page in each date, on the realizable date 502, the actual reward date or the average count during the rewarding period. The way to calculate the value of the denominator of contribution ratio 68 is decided, and then the way to calculate page production 66 should be adjusted accordingly. As for the value of numerator of the contribution ratio 68, one can count the remained contribution on the date of realizable date, on the actual reward date or each individual date's remained contribution. Based on the above, there are a group of combinations to use the equation in FIG. 5b. One of the example is the denominator is an average count for the content of the page during the rewarding time, numerator is a count of remained contribution on the actual reward date and the page production is the total page production over such rewarding time.

Since the content of the page include not only words but also other information format, the numerator of the contribution ratio 68 in one embodiment would be a count value for numeric data, table or even pictures. Once upon the way to calculate the value of the numerator of contribution ratio 68 is decided, the way to calculate the value of the denominator of contribution ratio 68 should be adjusted accordingly. Different kinds of calculation formula for contribution ratio 68 could be employed in accordance with the main concept of the contribution ratio: an evaluation to show the value of a contribution in a page by a contributor. In a special situation, when original contribution contained some non-sense sentences or intentional or malicious misleading information or even a cheating, a modified equation to the equation in FIG. 5b would be used. The modified equation uses the original equation in FIG. 5b to multiply an adjusting factor that is a non-zero integer and is smaller than one, to decrease the credit value the contributor may receive from the original equation in FIG. 5b.

In the step 220, a user decides to realize credits. This platform allows an exchange of credits with service. The rationale is that the credits are gained by providing service and such credits should be able to be realized into service too. The service could have a result in the following format such as math, logical signs, words, arts, painting, edition, table, drawings, pictures, multimedia presentation, sound, music and etc. The above results are a kind of copyrightable works, i.e. the work is attached to a storage media and the work has its author or authors. To enrich the content of the platform, in one embodiment, platform could only allow an exchange of credits with service that generates a copyrightable work.

Here are a group of examples for services could be rendered in the platform.

Edit a page in the platform.

Question and answer in real time or off-line. (Different prices)

How to, or teaching

Translation including translation of tags and descriptions.

Comparing two products or two things

Playing music

Drawing, maps design, picture, or presentation like power point edition

Consulting as professional

Other services that generate not-copyrightable service result.

The service exchange steps (step 222 to step 228) like an online shopping or auction process. In step 222, user holds credits could request a service by posting a description of request or find service providers by searching their posts. The service price is decided by the demand side and supply side. If both sides had agreed a transaction, the platform system will hold the credit need to pay in the step 224 just as the online payment service does. In step 226, the buyer inspects the service work and concludes the transaction. If both sides have dispute about the quality of work, a variety of dispute resolutions could be employed. In the step 228, if service result (resulted work) is a kind of copyrightable work, the service result will be saved in the platform. The buyer or in limited situation, service provider has the right to make such copyrightable work as an contribution to certain pages or even a new page, then execution continue to step 210.

From the above, I have described a method of receiving user's contribution to the community and a method of rewarding such contribution. More specially rewarding such contribution will increase the welfare of such community.

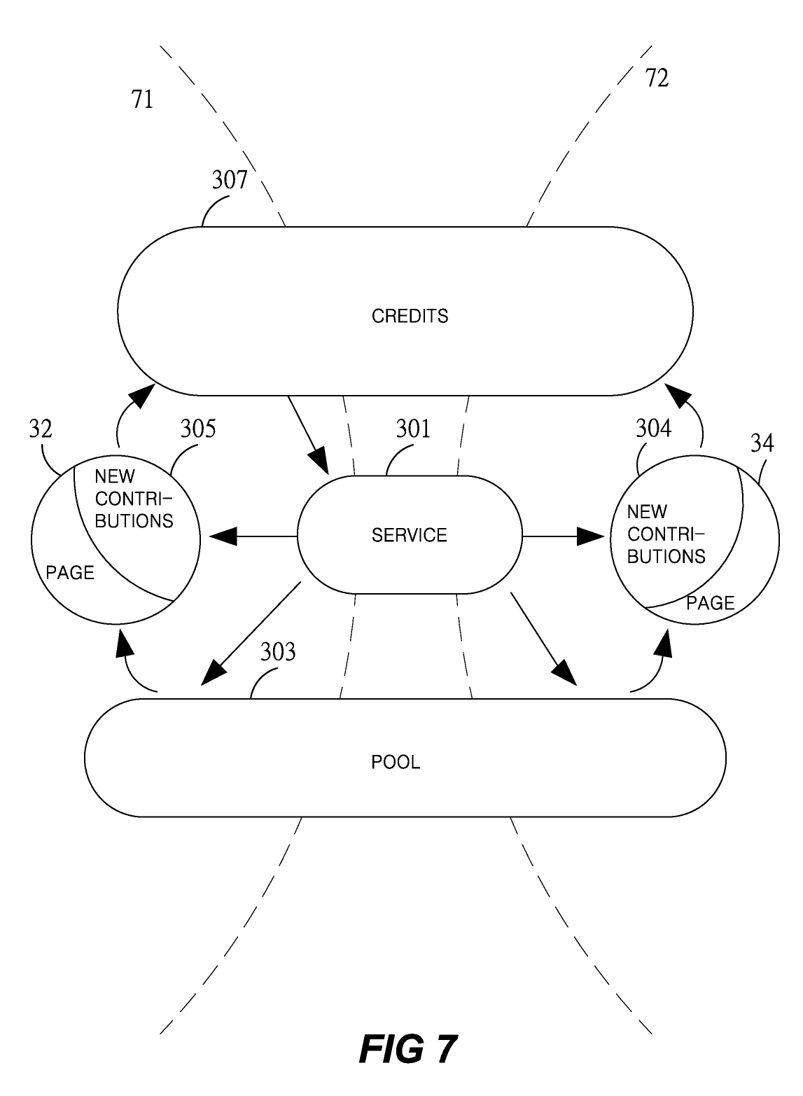

The benefit of rewarding system will also improve the culture or knowledge exchange between different countries. FIG. 7 shows a system network employing the cooperative platforms 71 and 72 in two different languages areas for example one is in Taiwan and the other is in Philippine. Each platform uses different language. The Page 34 in the platform 72 uses a language other than the language used in the platform 71 and the page 34 contains tags or keywords in a language understandable by the user in the platform 71, for example English. User in the platform 71 found page 34 in the platform 72 by searching keywords and reviewed the page's picture or drawing. The user found the page 34 interesting and wants to understand page 34. The user used credits to exchange a service—a translation service 301. Then a portion or all page 34 is translated in the step 226, said translation work will be saved in the pool 303 of the platform 71 in the step 228. If the user asking for translation service wants to make a contribution to the article area 44 of the page 32, the translation work will go directly from 301 to 305. If user asking for translation service did not contribute such translation work in platform 71 and a second user searched the pool 303 and found the article. The second user could make a contribution to the page 32. The contribution will follow the step 210 to gain credits and is illustrated by the arrow from page 32 to this user's credit value 307. In similar situation, user in the platform 72 could ask for a translation work in a page of the platform 71. The user could make such resulted work as one contribution 304 in page 34. The system encourages an exploring other culture or foreign event by directly reviewing what local people said about their culture or event. By implementation of this embodiment, people in different platforms could know each other in a better way.

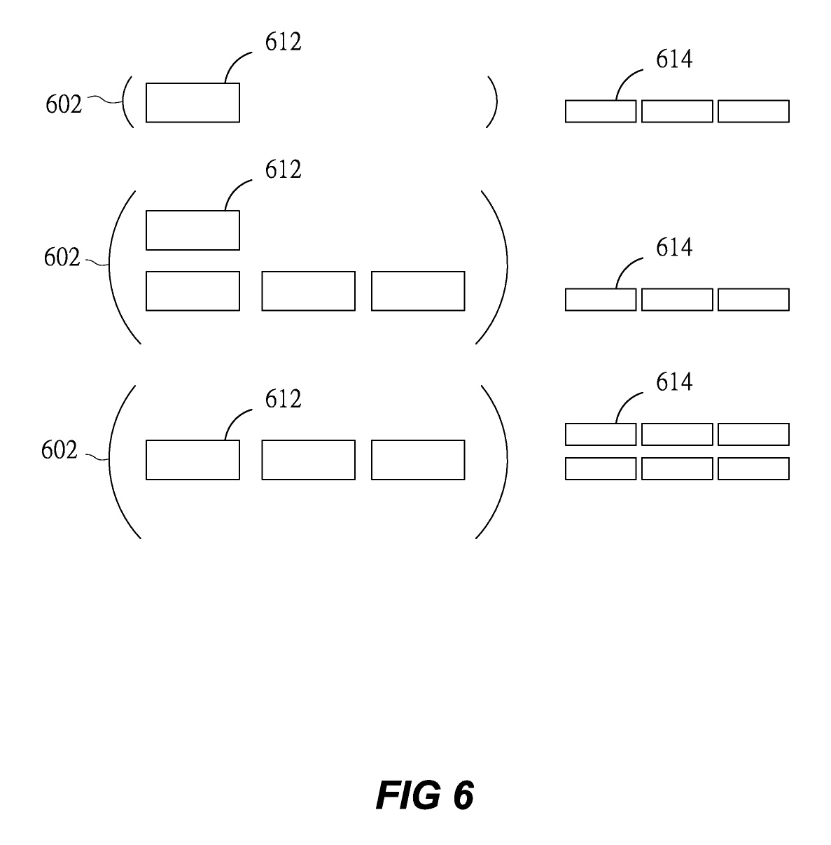

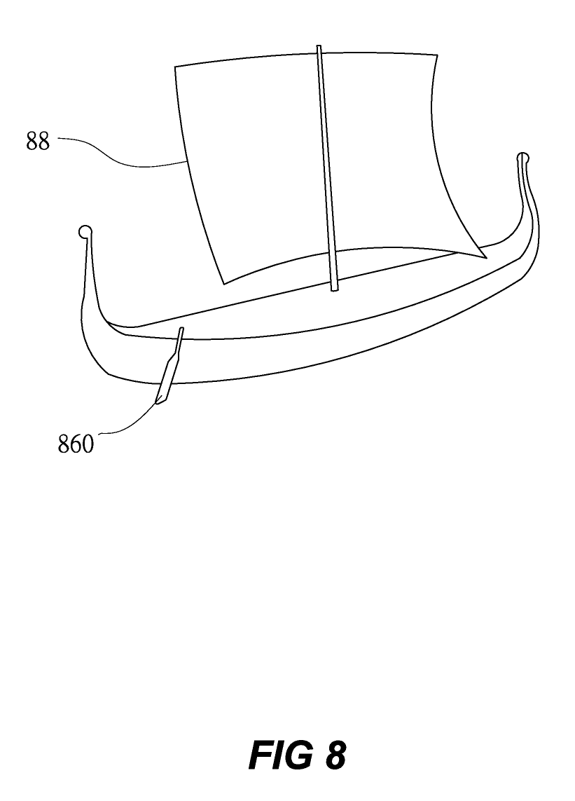

FIG. 6 shows the group of participants (including editor and contributor). One active participant 612 plays the main role in this stage 612 together with some interesting participants 614. The two sizes of rectangular box indicate the credits value hold by each participant. In the mature stage 603, the active participants 612 increase to four and interesting participants 614 decrease. In one embodiment, the active participants are the user with certain amount of not-realized credits (but realizable credits) obtained from the pages. It means that they have certain merits on the future development of the page. Finally in the next stage 604, more new participants join in. Not all pages have this stage. The contributions in the next start up stage may come from new area of the page other than the article area 44. For example, more new participants use twitter to input dynamic information or more participants discuss local events in the page. It is one of administrator's responsibility is to set a qualification for participants to be editors. Moreover the administrator should encourage editors' participation in editing tasks. There are two more responsibility administrator should take. Let us take the Viking ship 88 in FIG. 8 to illustrate the leader or administrator's responsibility. A ship leader should control a steering paddle 860 during the course of voyage in a right direction to avoid pirates or storms waiting for the Viking ship. Similarly an administrator should control the direction during the page development procedure and overcomes vandalism or intended attacks from competitors. Ancient wisdom is always inspiring. “Laget om” (“around the team”), a phrase used in Viking era to specify how much mead one should drink from the horn as it was passed around in order for everyone to receive a fair share. Therefore, it is also one of an administrator's jobs to maintain a fair rule and management schemes to prevent cheat. As a team leader, an administrator has responsibility to improve the page and let the page produces more page production, the editors themselves have similar goals with slightly different motivation. Editors have merits on a page since they would benefit themselves from the growth of the page production. However administrators may have motivation from reputation or frame. Therefore in an embodiment that only rewards copyrightable work, it is designed to reward administrators more reputation points and less even no credit rewarded when performing the administration work since administration work would not often generate copyrightable work.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for evaluating and rewarding a contribution of a user in an Internet system comprising a user profile including a reputation data and a credit data, comprising:
receiving said contribution from said user;
presenting said contribution in a page subject to a second user's modification so that a remained contribution is formed;
calculating a first time period based on said user's reputation data to form a first date;
evaluating said remained contribution to form a contribution ratio;
obtaining a page production value of said page accumulated over a second time period;
rewarding said user a credit on a user selected date, said user selected date is later than or equal to said first date and said credit is calculated from said contribution ratio and said page production value; and
whereby said user can realize said credit with a service through said Internet system.

2. The method of claim 1 wherein said second time period is same with said first time period when said user selected date is equal to said first date.

3. The method of claim 1 wherein said contribution ratio is form by dividing a count value of said remained contribution with a count value of at least of a portion of said page.

4. The method of claim 1 wherein said contribution is an article contribution.

5. The method of claim 1 wherein said contribution is a multimedia contribution.

6. The method of claim 1 wherein said modification is an edition work and said edition work improves the accuracy of the contribution or improves the accumulating rate of said page production value.

7. The method of claim 6, further including an editor to perform said edition work and said editor has a merit on said page.

8. The method of claim 6, further including an administrator and an editor, said administrator sets a qualification to select an editor to perform said edition work.

9. The method of claim 1, further including an administrator, said administrator sets a rule for said credit calculation from said contribution ratio and said page production value.

10. The method of claim 9, wherein said credit calculation includes a multiplication of a original credit with a not-zero integer, said not-zero integer factor is less than one.

11. The method of claim 1, further including an administrator, said administrator scales said first time period by multiplying an unstable factor, said unstable factor is greater than one and represents a controversial level of said page.

12. The method of claim 1, wherein said reputation data of said user is a value that predicts numbers of said modification will occur on said contribution of said user.

13. A system for evaluating and rewarding a contribution of a user, including:
a storage contained a user profile with a reputation data and a credit data;
a platform to receive said contribution from said user;
a processor; and
a memory coupled with the processor, wherein the memory is configured to provide processor with instructions which when executed cause the processor to:
present said contribution in a page subject to a second user's modification so that a remained contribution is formed;
calculate a first time period based on said user's reputation data to form a first date;
evaluate said remained contribution to form a contribution ratio;
obtain a page production value of said page accumulated over a second time period;
reward said user a credit on a user selected date, said user selected date is later than or equal to said first date and said credit is calculated from said contribution ratio and said page production value; and
whereby said user can realize said credit with a service.
